(19) United States
(12) Patent Application Publication
(10) Pub. No.: US 2023/0001633 A1
(43) Pub. Date: Jan. 5, 2023

(54) METHOD FOR MANUFACTURING THREE-DIMENSIONAL MODELED OBJECT, AND THREE-DIMENSIONAL MODELING DEVICE

(71) Applicant: Konica Minolta, Inc., Tokyo (JP)

(72) Inventors: Takeshi KOJIMA, Tokyo (JP); Shigeki TAKENOUCHI, Tokyo (JP)

(21) Appl. No.: 17/426,094

(22) PCT Filed: Jan. 31, 2020
(86) PCT No.: PCT/JP2020/003604

§ 371 Date: Jul. 27, 2021

(30) Foreign Application Priority Data
Feb. 5, 2019 (JP) 2019-018741

(51) Int. Cl. B29C 64/135; B33Y 10/00; B33Y 30/00; B33Y 40/00; B29C 64/364; B29C 64/268

(52) U.S. Cl. CPC B29C 64/135; B33Y 10/00; B33Y 30/00; B33Y 40/00; B29C 64/364; B29C 64/268; B29K 2105/16

(57) ABSTRACT

The present invention addresses the problem of providing: a method for manufacturing a three-dimensional modeled object, with which it is possible to fabricate a three-dimensional modeled object having high strength, using electron beam irradiation. In order to solve said problem, this method for manufacturing a three-dimensional modeled object comprises: a thin layer formation step in which a composition containing a radical polymerizable compound is applied to form a thin layer; and an electron beam irradiation step in which said thin layer is subjected to electron beam irradiation, and the radical polymerizable compound is cured to form a modeled object layer. The thin layer formation step and the electron beam irradiation step are repeated a number of times to layer the modeled object layer. The electron beam irradiation step is carried out in an atmosphere having an oxygen concentration from 50 ppm to less than 5,000 ppm.

### TECHNICAL FIELD

The present invention relates to a method for producing a three-dimensional shaped object and a three-dimensional modeling apparatus.

### BACKGROUND ART

In recent years, various methods that can relatively easily produce three-dimensional shaped objects having complex shapes have been developed. As one of the methods for producing a three-dimensional shaped object, known is a method to selectively irradiate a liquid resin composition containing a photosensitive resin with ultraviolet light to cure the resin composition into a desired shape (for example, Patent Literature (hereinafter, referred to as “PTL” 1). In the method described in PTL 1, a resin composition containing a photosensitive resin is irradiated with ultraviolet light in a pattern to form a cured product, namely a finely divided three-dimensional shaped object in the thickness direction. Then, a layer composed of the liquid resin composition is further ⁻finned on the cured. product, and is irradiated with ultraviolet light in a pattern. The formation of the layer composed of the liquid resin composition and the irradiation with the ultraviolet light (curing of the resin composition) are repeated to produce a three-dimensional shaped object having a desired shape.

### CITATION LIST

### Patent Literatures

Japanese Patent Application Laid-Open No. H8-174680

SUMMARY OF INVENTION

### Technical Problem

Methods such as the method described in PTL 1 typically use, as a resin composition, a composition containing a photocurable compound, a photopolymerization initiator, and the like. However, a three-dimensional shaped object obtained from such a resin composition is more likely to be colored due to the influence of the photopolymerization initiator. Further, a resin composition containing a photopolymerization initiator is more likely to thicken due to the reaction of the polymerization initiator during storage, which leads to difficulty of handling the composition.

It is conceivable to use an electron beam for irradiation in place of ultraviolet light. Irradiating with an electron beam has an advantage such that a photopolymerization initiator causing coloring is not necessary. However, it is difficult to adjust the degree of curing of a three-dimensional shaped object when an electron beam is used. For example, when a resin composition is sufficiently cured, the adhesiveness with the next layer to be formed becomes low, and peeling is more likely to occur between the layers. On the other hand, when the resin composition is not sufficiently cured, the strength of the entire three-dimensional shaped object model tends to decrease. There is thus a disadvantage on using electron beam irradiation such that the production of a three-dimensional shaped object having sufficient strength is difficult.

The present invention has been made in view of the above disadvantage. An object of the present invention is to provide a method for producing a three-dimensional shaped object, which is capable of producing a three-dimensional shaped object having high strength, by using electron beam irradiation, and a three-dimensional modeling apparatus to be used for this method.

### Solution to Problem

The present invention provides a method for producing a three-dimensional shaped object as follows.

[1] A method for producing a three-dimensional shaped object, which includes thin layer forming of applying in a pattern a composition for three-dimensional modeling containing a radical polymerizable compound to form a thin layer; and electron beam radiating of irradiating the thin :layer with an electron beam to form a shaped object layer with the radical polymerizable compound being cured therein, wherein the thin layer forming and the electron beam radiating are repeated a plurality of times to stack a plurality of the shaped object layers on top of one another to produce a three-dimensional shaped object, and wherein the electron beam radiating is performed in an atmosphere having an oxygen concentration of 50 ppm or more and less than 5,000 ppm.

[2] The method for producing a three-dimensional shaped object according to [1], wherein the composition for three-dimensional modeling is applied by a discharge method in the thin layer funning.

[3] The method for producing a three-dimensional shaped object according to [1], Wherein the composition for three-dimensional modeling contains a filler.

The present invention provides a three-dimensional modeling apparatus as follows.

[4] A three-dimensional modeling apparatus, comprising: a shaping stage; an application area including an application part for applying a three-dimensional modeling composition on or above the shaping stage; and an electron beam irradiation area including an electron beam irradiation part for irradiating, with an electron beam, the three-dimensional modeling composition applied in the application area, wherein the three-dimensional modeling apparatus is provided with an oxygen concentration adjustment part for adjusting an oxygen concentration in the electron beam irradiation area.

[5] The three-dimensional modeling apparatus according to [4], further comprising: a transport mechanism capable of transporting the shaping stage, wherein the shaping stage is moved between the application area and the electron beam irradiation area.

### Advantageous Effects of Invention

The method for producing a three-dimensional shaped object of the present invention can produce a three-dimensional shaped object having high strength by using electron beam irradiation.

### BRIEF DESCRIPTION OF DRAWINGS

FIGS. 1A to 1C illustrate a process for explaining a method for producing a three-dimensional shaped object according, to an embodiment of the present invention; and

FIG. 2 is a schema is view for explaining a three-dimensional modeling apparatus according to an embodiment of the present invention.

### DESCRIPTION OF EMBODIMENTS

1. Method for Producing Three-dimensional Shaped Object

The method for producing a three-dimensional shaped object of the present invention includes a thin layer forming step of applying a composition for three-dimensional modeling (herein also referred to as “three-dimensional modeling composition”) containing a radical polymerizable compound to form a thin layer; and an electron beam radiating step of irradiating the thin layer with an electron beam to form a shaped object layer, in which the radical polymerizable compound is cured. The method produces a three-dimensional shaped object by alternately repeating the thin layer forming step and the electron beam radiating step a plurality of times to stack the shaped object layers on top of one another.

As described above, a three-dimensional modeling composition has typically been irradiated with ultraviolet light to cure. However, it is necessary to add a photopolymerization initiator to a three-dimensional modeling composition to cure the three-dimensional modeling composition with ultraviolet light. The addition of the photopolymerization initiator results in disadvantages such as coloring of the obtained three-dimensional shaped object, and lowering of the storage stability of the three-dimensional modeling composition.

The use of an electron beam for irradiation in place of ultraviolet light results in another disadvantage such that a three-dimensional shaped object having high strength cannot be obtained. During electron beam irradiation, the curability of a three-dimensional modeling composition mainly depends on the acceleration voltage of an electron beam and the irradiation amount of the electron beam (hereinafter also referred to as “electron beam irradiation amount”). The acceleration voltage correlates with the reachability of the electron beam in the depth direction, and the electron beam irradiation amount correlates with the degree of curing.

When shaped object layers are stack on top of one another to obtain a three-dimensional shaped object as in the present invention, an increased acceleration voltage of the electron beam and an increased electron beam irradiation amount greatly improve the curability of the shaped object layers. However, in this case, there are few bonding points left on the surface of the previously formed shaped object layer for bonding with the shaped object layer to be formed later. The adhesive strength between the layers becomes very low, and thus peeling is more likely to occur between these layers.

On the other hand, when the acceleration voltage of the electron beam is reduced and the electron beam. irradiation amount is also reduced, the three-dimensional modeling composition is not sufficiently cured, thereby lowering the strength of the three-dimensional shaped object. Alternatively, when the acceleration voltage of the electron beam is reduced and the electron beam irradiation amount is increased, only the surface side of a shaped object layer is cured, and the curability of the inside and the bottom of the layer is lowered. The strength of the three-dimensional shaped object is also lowered in this case. Further, when the acceleration voltage of the electron beam is increased and the electron beam irradiation amount is reduced, the curability of the entire shaped object layer is also uniformly lowered, thereby also lowering the strength of the three-dimensional shaped object. That is, in three-dimensional shaping methods using electron beam irradiation, no matter how the acceleration voltage of the electron beam and the electron beam irradiation amount are adjusted, sufficient strength cannot be obtained.

Typical electron beam irradiation is performed under the condition with substantially no oxygen. This is because the presence of oxygen causes oxygen inhibition to cause poor curing. In the present invention, on the other hand, electron beam irradiation for curing a thin layer (three-dimensional modeling composition) is performed in an atmosphere having an oxygen concentration of 50 ppm or more and less than 5,000 ppm to intentionally cause curing inhibition on the surface of the thin layer of the three-dimensional modeling composition. That is, even when the acceleration voltage of the electron beam is relatively increased and the electron beam irradiation amount is also relatively increased, many reaction points remain on the surface of the previously formed shaped object layer for reacting with the shaped object layer to be formed later. Then, when the shaped object layer formed later is cured, the surface of the previously formed shaped object layer can be simultaneously cured by relatively increasing the acceleration voltage of the electron beam and also relatively increasing the electron beam irradiation amount Such a configuration is less likely to generate regions having low curability over the entire three-dimensional shaped object, thereby obtaining the three-dimensional shaped object having high strength.

Hereinafter, each step in the method for producing a three-dimensional shaped object of the present invention will be described in detail. in addition to the thin layer forming step and the electron beam radiating step, the method for producing a three-dimensional shaped object of the present invention may include, for example, a step of forming a support material for supporting a part of the shaped object layer in accordance with the shape of the three-dimensional shaped object to be produced.

1-1. Thin Layer Forming Step

The thin layer forming step is a step of applying a three-dimensional modeling composition containing a radical polymerizable compound to form a thin layer. The three-dimensional modeling composition is applied on a shaping stage of a three-dimensional modeling apparatus, on a shaped object layer formed in advance (layer forted by the previously performed thin layer forming step and electron beam radiating step), and/or on an optionally formed support material. The thin layer has a pattern obtained by finely dividing a desired three-dimensional shaped object in its thickness direction.

The method for applying a three-dimensional modeling composition may be any method that can apply the three-dimensional modeling composition in a desired pattern. Examples of the applying method include an inkjet method, a discharge method that applies the composition with a dispenser or a jet dispenser, a screen printing method, a stencil printing method, and an intaglio printing method. In particular, the discharge method is preferable from the viewpoint that the thin layers can be formed in various patterns. The discharge method herein refers to a method in which a three-dimensional modeling composition is discharged from a nozzle or the like and landed at a desired position.

The thickness of the thin layer formed in the thin layer forming step is preferably 0.01 to 2 non, more preferably 0.05 to 0.5 mm, and even more preferably 0.08 to 0.15 mm. When the thickness of the thin layer is 2 mm or less, the electron beam can sufficiently reach the bottom of the thin layer to sufficiently cure the thin layer in the electron beam radiating step described below. When the thickness of the thin layer is 0.01 mm or more, it is possible to efficiently form a three-dimensional shaped object. When a desired thickness cannot be obtained by one application, the application of the three-dimensional modeling composition may be repeated until the desired thickness is obtained.

The three-dimensional modeling composition applied in this step contains at least a radical polymerizable compound, and may further contain, for example, a filler, an inert resin, an antioxidant, an ultraviolet absorber, a flame retardant, and/or a colorant, as needed.

The radical polymerizable compound has a radically polymerizable group that is polymerized by irradiation with an electron beam. The three-dimensional modeling composition may contain only one type of radical polymerizable compound or may contain two or more types of radical polymerizable compounds. Examples of the radical polymerizable compounds include compounds each haying one or more of an ethylene group, a propenyl group, a butenyl group, a vinylphenyl group, an allyl ether group, a vinyl ether group, a maleyl group, a maleimide group, a (meth) acrylamide group, an acetylvinyl group, a vinylamide group, and a (meth) acryloyl group in the molecule.

In particular, the radical polymerizable compound is preferably an unsaturated carboxylate compound having one or more unsaturated carboxylate structures in the molecule, or an below described unsaturated carboxylic acid amide compound having one or more unsaturated carboxylic acid anode structures in the molecule. The radical polymerizable compound is particularly preferably the below described (meth)acrylate-based compound and/or (meth)acrylamide-based compound having a (meth)acryloyl group. Herein, the term “(meth)acryl” represents methacryl and/or acryl, the term “(meth)acryloyl” represents methacryloyl and/or acryloyl, and the term “(meth)acrylate” represents methacrylate and/or acrylate.

Any known compound may be used as the radical polymerizable compound. Examples of the “compound having a (meth)acrylamide group” described above include (meth)acrylamide, N,N-dimethyl (meth)acrylamide, N-ethyl (meth)acrylamide, N-isopropyl (meth)acrylamide, N-hydroxyethyl (meth)acrylamide, N-butyl (meth)acrylamide, isobutoxymethyl (meth)acrylamide, diacetone (meth)acrylamide, bismethyleneacrylamide, di(ethyleneoxy)bispropylacrylarnide, tri(ethyleneoxy)bispropylacrylamide, and (mettnacryloylmorpholine.

Examples of the “compound having a (meth)acryloyl group” described above include the following:

monofunctional (meth)acrylate monomers including isoarayl (meth)acrylate, stearyl (meth)acrylate, lauryl (meth)acrylate, butyl (meth)acrylate, pentyl (meth)acrylate, octyl (meth)acrylate, isooctyl (meth)acrylate, isononyl (meth)acrylate, decyl (meth)acrylate, isodecyl (meth)acrylate, tridecyl (meth)acrylate, isomyristyl (meth)acrylate, isostearyl (meth)acrylate, dicyclopentenyloxyethyl (meth)acrylate, dicyclopentenyl (meth)acrylate, 2-ethylhexyl (meth)acrylate, dimethylaminoethyl (meth)acrylate, diethylaminoethyl (meth)acrylate, 2-ethylhexyl-diglycol (meth)acrylate, 2-(meth)acryloyloxyethyl hexahydrophthalate, methoxyethoxyethyl (meth)acrylate, butoxyethyl (meth)acrylate, ethoxy diethylene glycol (meth)acrylate, methoxy diethylene glycol (meth)acrylate, methoxy polyethylene glycol (meth)acrylate, methoxy propylene glycol (meth)acrylate, phenoxyethyl (meth)acrylate, pentachlorophenyl (meth)acrylate, pentabromophenyl (meth)acrylate, tetrahydrofurfuryl (meth)acrylate, dicyclopentanyl (meth)acrylate, cyclohexyl (meth)acrylate, isobornyl (meth)acrylate, polyethylene glycol mono(meth)acrylate, polypropylene glycol mono(meth)acrylate, glycerin (meth)acrylate, 7-amino-3,7-dimethyloctyl (meth)acrylate, 2-hydroxyethyl (meth)acrylate, 2-hydroxypropyl (meth)acrylate, 2-hydroxybutyl (meth)acrylate, 2-hydroxy-3-phenoxypropyl (meth)acrylate, benzyl (meth)acrylate, 2-(2-ethoxyethoxy)ethyl (meth)acrylate, 2-ethylhexyl carbitol (meth)acrylate, 2-(meth)acryloyloxyethyl succinate, 2-(meth)acryloyloxyethyl phthalate, 2-(meth)acryloyloxyethyl-2-hydroxyethyl-phthalate, 2-(meth)acryloyloxyethyl hexahydrophthalate, and t-butylcyclohexyl (meth)acrylate;

bifunctional (meth)acrylate monomers including triethylene glycol di(meth)acrylate, tetraethylene glycol di(meth)acrylate, polyethylene glycol di(meth)acrylate, tripropylene glycol di(meth)acrylate, polypropylene glycol di(methlacrylate, 1,4butanediol di(meth)acrylate, 1,6-hexanediol di(meth)acrylate, 19-nonanediol di(meth)acrylate, cyclohexane di(meth)acrylate, cyclohexane dimethanol di(meth)acrylate, neopentyl glycol di(meth)acrylate, tricyclodecane diyldimethylene di(meth)acrylate, dimethylol-tricyclodecane di(meth)acrylate, polyester di(meth)acrylate, bisphenol A PO adduct di(meth)acrylate, hydroxypivalic acid neopentyl glycol di(meth)acrylate, polytetramethylene glycol di(meth)acrylate, polyethylene glycol di(meth)acrylate, tripropylene glycol di(meth)acrylate, and tricyclodecane dimethanol di(meth)acrylate;

trifunctional or higher functional (meth)acrylate monomers including trimethylolpropane tri(meth)acrylate, pentaerythritol tri(meth)acrylate, pentaerythritol tetra(meth)acrylate, dipentaerythritol penta(meth)acrylate, dipentaerythritol hexa(meth)acrylate, ditrimethylolpropane tetra(meth)acrylate, dipentaerythritol monohydroxy penta(meth)acrylate, glycerinpropoxy tri(meth)acrylate, and pentaerythritol ethoxy tetra(meth)acrylate; and

oligomers thereof.

The “compound having a (meth)acryloyl group” may also be one of compounds obtained by further modifying various (meth)acrylate monomers or oligomers thereof (modified products). Examples of the modified product include ethylene oxide-modified (meth)acrylate monomers such as triethylene glycol diacrylate, polyethylene glycol diacrylate, ethylene oxide-modified trimethylolpropane tri(meth)acrylate, ethylene oxide-modified pentaerythritol tetraacrylate, ethylene oxide-modified bisphenol A di(meth)acrylate, and ethylene oxide-modified nonylphenol (meth)acrylate; propylene oxide-modified (meth)acrylate monomers such as tripropylene glycol diacrylate, polypropylene glycol diacrylate, propylene oxide-modified trimethylolpropane tri(meth)acrylate, propylene oxide-modified pentaerythritol tetraacrylate, and propylene oxide-modified glycerin tri(meth)acrylate; caprolactone-modified (meth)acrylate monomers such as caprolactone-modified trimethylolpropane tri(meth)acrylate; and caprolactam-modified (meth)acrylate monomers such as caprolactam-modified dipentaerythritol hexa(meth)acrylate.

The “compound having a (meth)acryloyl group” may further be one of compounds obtained by (meth)acrylating various oligomers (hereinafter also referred to as “modified (meth)acrylate compounds”). Examples of such a modified (meth)acrylate compound include polybutadiene (meth)acrylate compounds, polyisoprene (meth)acrylate compounds, epoxy (meth)acrylate compounds, urethane (meth)acrylate compounds, silicone (meth)acrylate compounds, polyester (meth)acrylate compounds, and linear (meth)acryl compounds.

Examples of the radical polymerizable compounds also include N-vinyl compounds such as N-vinylpyrrolidone and N-vinylcaprolactam, and derivatives of allyl compounds such as allylglycidyl ether, diallyl phthalate, diallyl isophthalate, and triallyl trimellitate.

The three-dimensional modeling composition preferably contains the radical polymerizable compound in an amount of 5 mass % or more, more preferably 10 mass %, and even more preferably 20 mass %. A radical polymerizable compound contained at an amount of 20 mass % or more in the three-dimensional modeling, composition is more likely to sufficiently increase the strength of the obtained three-dimensional shaped object.

The filler contained in the three-dimensional modeling composition may he any filler, such as an organic filler or an inorganic filler. The three-dimensional modeling composition may contain only one type of filler or may contain two or more types of fillers.

Examples of the filler include glass fillers composed of soda lime glass, silicate glass, borosilicate glass, aluminosilicate glass, or quartz glass; ceramic fillers composed of alumina, zirconium oxide, titanium oxide, lead zircoaate titanate, silicon carbide, silicon nitride, aluminum nitride, boron nitride, or tin oxide; metal fillers composed of an element metal such as iron, titanium, gold, silver, copper, nickel, cobalt, aluminum, tin, lead, bismuth, cobalt, antimony, or cadmium, and alloys thereof; carbon fillers composed of graphite, graphene, or carbon nanotube; organic polymer fibers composed of polyester, polyimide, polyaramide, polyparaphenylene benzobisoxazole, or polysaccharides (for example, cellulose, hemicellulose, lignocellulose, chitin and chitosan); whisker-shaped inorganic: compounds composed of potassium titanate whiskers, silicone carbide whiskers, silicon nitride whiskers, α-alumina whiskers, zinc oxide whiskers, aluminum borate Whiskers, calcium carbonate whiskers, magnesium hydroxide whiskers, basic magnesium sulfate whiskers, or calcium silicate whiskers (also including needle-like monocrystals of the ceramic fillers described above); and clay minerals composed of talc, mica, clay, wollastonite, hectorite, saponite, stevensite, beidellite, montmorilionite, nontronite, bentonite, swellable micas such as Na-type tetrasilisic fluorine mica, Li-type tetrasilisic fluorine mica, Na-type fluorine taeniolite, or Li-type fluorine taeniolite, and clay minerals composed of vermiculite, imogolite, or halloysite. Examples of the fillers also include polyolefin fillers composed of, for example, polyethylene or polypropylene; and fluorine resin fillers composed of, for example, FEP (tetralluoroethylene-hexafluoropropylene copolymers), PFA (tetraftuoroethylene-perfluoroalkoxyethylene copolymers), ETFE (tetrafluoroethylene-ethylene copolymer).

The filler may have any shape, such as fibrous (including whisker-shaped), plate-shaped, or particulate.

When the filler is particulate, the average particle size thereof is preferably 0.005 to 200 μm, more preferably 0.01 to 100 μm, and even more preferably 0.1 to 50 μm. A particulate filler having an average particle size of 0.1 μm or more is more likely to increase the strength of a three-dimensional shaped object. A particulate filler having an average particle size of 50 μm or less is more likely to form a highly fine three-dimensional shaped object. The average particle size can be determined by taking an image of the three-dimensional modeling composition with a transmission electron microscope (TEM), analyzing the image, and obtaining the average of measured 100 or more filler particles.

When the filler is fibrous, the average fiber diameter thereof is preferably 0.002 μm or more and 20 μm or less. A filler having an average fiber diameter of 0.002 μm or more is more likely to increase the strength of a three-dimensional shaped object. A filler having an average fiber diameter of 20 μm or less does not excessively increase the viscosity of a three-dimensional modeling composition, and the three-dimensional modeling composition can be easily applied. The average fiber diameter of the filler is more preferably 0.005 μm or more and 10 μm or less, even more preferably 0.01 μm or more and 8 μm or less, and particularly preferably 0.02 μm or more and 5 μm or less.

The average fiber length of the filler is preferably 0.2 μm or more and 200 μm or less. A filler having an average fiber length of 0.2 μm or more is more likely to increase the strength of a three-dimensional shaped object. A filler having an average fiber length of 100 μm or less is less likely to settle in a three-dimensional modeling composition. The average fiber length of the filler is more preferably 0.5 μm or more and 100 μm or less, even more preferably 1 μm or more and 60 μm or less, and particularly preferably 1 μm or more and 40 μm or less.

The aspect ratio of the filler is preferably 10 or more and 10,000 or less. A filler having an aspect ratio of 10 or more is more likely to increase the strength of a three-dimensional shaped object. A filler having an aspect ratio of 10,000 or less is less likely to settle caused by the entanglement among filler fibers. The aspect ratio of the filler is more preferably 12 or more and 8,000 or less, even more preferably 15 or more and 2,000 or less, and particularly preferably 18 or more and 800 or less.

The average fiber diameter, average fiber length, and aspect ratio of a filler can be determined by taking an image of the three-dimensional modeling composition with a transmission electron microscope (TEM), analyzing the image, and obtaining the average of 100 or more filler fibers.

When the filler is plate-shaped, the thickness thereof is preferably 0.002 μm or snore and 20 μm or less. A filler having an average thickness of 0.002 μm or more is more likely to increase the strength of a three-dimensional shaped object. A filler having an average thickness of 20 μm or less does not excessively increase the viscosity of a three-dimensional modeling composition, and the three-dimensional modeling composition can be easily applied. The average thickness of the filler is more preferably 0.005 μm or more and 10 μm or less, even more preferably 0.01 μm or more and 8 μm or less, and particularly preferably 0.02 μm or more and 5 μm or less.

The average length of the plate-shaped filler in the plane direction is preferably 0.2 μm or more and 200 μm or less. A filler having an average length in the plane direction of 0.2 μm or more is more likely to increase the strength of a three-dimensional shaped object. A filler having an average length in the plane direction of 100 μm or less is less likely to settle in a three-dimensional modeling composition. The average length of the filler in the plane direction is more preferably 0.5 μm or more and 100 μm or less, even more preferably 1 μm or more and 60 μm or less, and particularly preferably 1 μm or more and 40 μm or less.

The aspect ratio of the plate-shaped filler is preferably 10 or more and 10,000 or less. A filler having an aspect ratio of 10 is more likely to increase the strength of a three-dimensional shaped object. A filler having an aspect ratio of 10,000 or less is less likely to settle caused by the entanglement among filler fibers. The aspect ratio of the filler is more preferably 12 or more and 8,000 or less, even more preferably 15 or more and 2,000 or less, and particularly preferably 18 or more and 800 or less.

The average thickness, average length in the plane direction, and aspect ratio of a plate-shaped filler can be determined by taking an image of the three-dimensional modeling composition with a transmission electron microscope (TEM), analyzing the image, and obtaining the average of 100 or more filler fibers.

The amount of a filler contained in the three-dimensional modeling composition is preferably 1 to 90 mass %, more preferably 5 to 50 mass %. A filler whose amount is within the above range is more likely to make the obtainment of a three-dimensional shaped object having high strength easy.

The filler may be surface-treated with any one of various surface treatment agents such as known silane coupling agents. A surface-treated filler has enhanced adhesion to a radical polymerizable compound, and thus is more likely to make the obtainment of a three-dimensional shaped object having high strength easy.

The viscosity of the three-dimensional modeling composition measured at 25° C. with a rotary viscometer by a method according to JIS K-7117-1 is preferably 0.05 to 10 Pa·s, more preferably 0.5 to 5 Pa·s. When the viscosity of the three-dimensional modeling composition is within the above range, the shape of the applied three-dimensional modeling composition does not change excessively, and a thin layer having a desired thickness can be formed.

1-2. Electron Beam Radiating Step

The electron beam radiating step is a step of irradiating a thin layer formed in the above-described thin layer forming step with an electron beam to form a shaped object layer that includes a cured radical polymerizable compound. Examples of methods for generating electron beams include a scanning method, a curtain beam method, and a broad beam method. In particular, a curtain beam method is preferable from the viewpoint of generating electron beams efficiently. Examples of light sources capable of radiating electron beams include CURETRON EBC-200-20-30, manufactured by NHV Corporation, and Min-EB, manufactured by AIT.

The acceleration voltage during electron beam irradiation is preferably 1 kV or more and 1,000 kV or less, more preferably 10 kV or more and 300 kV or less. An acceleration voltage within the above range is more likely to allow the electron beans to reach the bottom side of a thin layer formed in the above-described thin layer forming step and also the surface of a previously formed shaped object layer.

The electron beam irradiation amount is preferably 1 kGy or more and 1,000 kGy or less, more preferably 10 key or more and 200 kGy or less. When the electron dose is in this range, a three-dimensional modeling composition is sufficiently cured.

The oxygen concentration in the atmosphere during electron beam irradiation is 50 ppm or more and less than 5,000 ppm, preferably 60 ppm or more and 1,000 ppm or less, and more preferably 80 ppm or more and 500 ppm or less. When the oxygen concentration in the atmosphere during electron beam irradiation is within tins range, oxygen inhibition is more likely to occur on the surface of a thin layer, and the adhesive strength with the next shaped object layer to be firmed is more likely to increase. Excessive occurrence of oxygen inhibition may lower the strength of the three-dimensional shaped object because of insufficient curing. The oxygen concentration is thus preferably less than 5,000 ppm. The oxygen concentration can be measured by, for example, an oxygen analyzer using a zirconia oxygen sensor. The oxygen concentration in the atmosphere is measured by placing the oxygen sensor in the vicinity of a three-dimensional shaped object.

1-3. Other Steps

The method for producing a three-dimensional shaped object of the present invention produces a desired three-dimensional shaped object by alternately repeating the thin layer forming step and the electron beam radiating step. The shape of some three-dimensional shaped object may have a dent on a part of its outer surface or a gap in its inside. In addition to the above-described thin layer forming step and electron beam radiating step, the method for producing a three-dimensional shaped object of the present invention may also include a step of forming a support material layer (hereinafter, also referred to as a “support material forming step”).

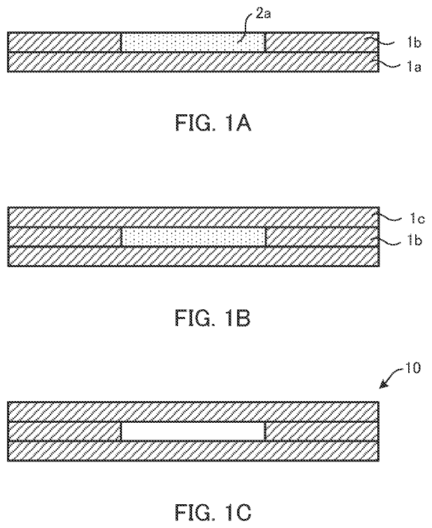

A case where the support material forming step is performed will be described with FIGS. 1A to 1C as an example. As illustrated in FIG. 1A, shaped object layer 1b and support material layer 2a are produced on previously formed shaped object layer 1a (or on a shaping stage stage), As illustrated in FIG. 1B, shaped object layer 1c is then formed on shaped object 1b and support material layer 2a. Removing support material 2a can produce three-dimensional shaped object 10 with a dent(s) and/or a gap(s) (a gap in FIGS. 1A to 1C) as illustrated in FIG. 1C.

The support material layer can be formed by applying a composition for a support material (herein also referred to as “support material composition”) and curing the composition. A resin or the like that can he cured with, for example, an electron beam or heat and its cured product is water-soluble or water-swellable can be used as the support material composition.

Examples of the resin that can be cured with an electron beam and its cured product is water-soluble or water-swellable include water-soluble (meth)acrylates such as polyoxyethylene di(meth)acrylate, polyoxypropylene di(meth)acrylate, (meth)acryloyl morpholine, and hydroxyalkyl (meth)acrylate; and water-soluble (meth)actylamides such as (meth)acrylamide, N,N-dimethyl (meth)acrylamide, and N-hydroxyethyl (meth)acrylamide. Resins suitable for the support material composition also include water-soluble polymers such as polyethylene glycol, polypropylene glycol, and polyvinyl alcohol.

The method for applying the support material composition may be any method, which may be the same as the method for applying a three-dimensional modeling composition in the above-described thin layer forming step. Applying the support material composition in the same manner as in applying the three-dimensional modeling composition eliminates the necessity of changing of a device for applying the support material composition. This configuration allows efficient production of a three-dimensional shaped object. Among the above-described applying methods, the discharge method is preferable from the viewpoint that the support material can be formed in various patterns. The coating film thickness of the support material composition is preferably the same as the thickness of the thin layer formed in the above-described thin layer forming step.

The method for curing the support material composition may be any method such as thermosetting, but is preferably a method capable of curing the composition with an electron beam. Curing with an electron beam allows the support material composition to be cured together with the thin layer (resin composition for three-dimensional modeling) formed in the above-described thin layer forming step, thereby efficiently producing the three-dimensional shaped object.

2. Three-Dimensional Modeling Apparatus

A three-dimensional modeling apparatus that can be used in the above-described method for producing a three-dimensional shaped object will be described below. However, the apparatus for performing the above-described method for producing a three-dimensional shaped object is not limited to the following three-dimensional modeling apparatus.

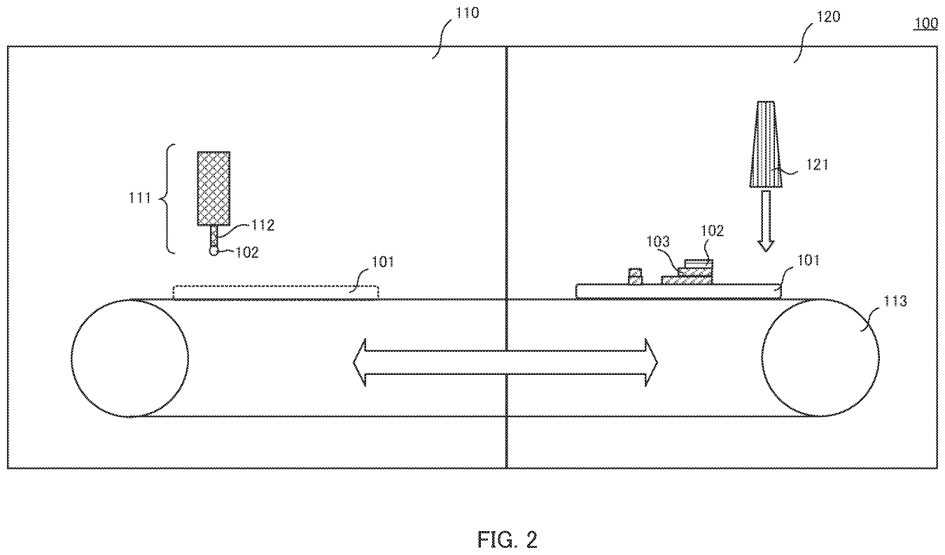

FIG. 2 schematically illustrates the three-dimensional modeling apparatus of the present invention. Three-dimensional modeling apparatus 100 includes shaping stage 101, application area 110 including application part 111 for applying three-dimensional modeling composition 102 on shaping stage 101, and electron beam irradiation area 120 including electron beam irradiation part 121 for irradiating applied three-dimensional modeling composition 102 with an electron beam. Electron beam irradiation area 120 is also provided with oxygen concentration adjustment part (not shown) for adjusting the oxygen concentration. Three-dimensional modeling apparatus 100 also includes transport mechanism 113 for moving shaping stage 101 between application area 110 and electron beam irradiation area 120 (moving shaping stage 101 from application area 110 to electron beam irradiation area 120 and from electron beam irradiation area 120 to application area 110 repeatedly).

Application area 110 and electron beam irradiation area 120 of three-dimensional modeling apparatus 100 may communicate with each other, or may be separated by a partition or the like. In three-dimensional modeling apparatus 100 illustrated in FIG. 2, application area 110 and electron beam irradiation area 120 are separated by a. partition that can be opened and closed, from the viewpoint that the oxygen concentration in electron beam irradiation area 120 can be easily controlled. The application area 110 side in three-dimensional modeling apparatus 100 may be in an inert gas atmosphere or in the air atmosphere.

Transport mechanism 113 may have any structure that can transport shaping stage 101 to application area 110 and electron beam irradiation area 120, and may be, for example, a belt conveyor.

Shaping stage 101 is a structure for supporting uncured three-dimensional modeling composition 102 and cured three-dimensional modeling composition (that is, shaped object layer 103). Shaping stage 101 is a member having a flat plate shape in FIG. 2 but may have any shape, which is appropriately selected according to the shape of a desired three-dimensional shaped object. Apart of transport mechanism 113 may also serve as shaping stage 10:1. Shaping stage 101 is composed of any material that is not eroded by three-dimensional modeling composition 102 and can withstand electron beam irradiation. A release layer or the like may be formed on the surface in order to facilitate the release of the formed three-dimensional shaped object (not shown).

Application part 111 disposed in application area 110 may be any type of part that can apply three-dimensional modeling composition 102 into a desired shape on shaping stage 101 or on previously formed shaped object layer 103. Application part 111 may be, for example, a dispenser unit provided with a tank (not shown) for storing three-dimensional modeling composition 102 and dispenser needle 112. However, application part 111 is not limited to the above unit, and may be, for example, any one of units provided with tanks for storing the three-dimensional modeling composition and various types of nozzles. Application part 111 may also be a screen printing unit or the like. In particular, from the viewpoint that three-dimensional modeling composition 102 can be easily applied. in a desired pattern, application part 111 is particularly preferably a dispenser unit or the like.

Electron beam irradiation part 121 disposed in. electron beam irradiation area 120 may be any unit of any method that can irradiate with an electron beam three-dimensional modeling composition 102 applied by application part 111 of application area 110. Examples of the irradiation method include a scanning method, a curtain beam method, and a broad beau method. In particular, a curtain beam method is preferable from the viewpoint of generating electron beams efficiently.

In addition, oxygen concentration adjustment part (not shown) disposed in electron beam irradiation area 120 may be any unit that can adjust the oxygen concentration in electron beam irradiation part 120. The oxygen concentration adjustment part may be, for example, a unit including a measuring unit (not shown) for measuring the oxygen concentration, an oxygen supply unit (not shown) for supplying oxygen into electron beam irradiation area 120 as needed, and an inert gas supply unit (not shown) for supplying an inert gas (for example, nitrogen) into electron beam irradiation area 121) as needed.

Firstly, shaping stage 101 is disposed on the application area 110 side in three-dimensional modeling apparatus 100. Application part 111 applies three-dimensional modeling composition 102 in a desired pattern onto shaping stage 101. Three-dimensional modeling composition 102 may be applied while shaping stage 101 is stopped at a predetermined position or while transport mechanism 113 or the like moves shaping stage 101 toward the electron beam irradiation area 120 side.

Secondly, a partition (not shown) between application area 110 and electron beam irradiation area 120 is opened, and transport mechanism 113 moves shaping stage 101 to the electron beam irradiation area 120 side. While the partition is opened, the oxygen concentration adjustment pad (not shown) adjusts the oxygen concentration in electron beam. irradiation area 120 so that the oxygen concentration does not change significantly.

The partition (not shown) is then closed, and electron beam irradiation is performed after the oxygen concentration in electron beam irradiation area 120 is set to fall within a range of 50 ppm or more and less than 5,000 ppm. The acceleration voltage of the electron beam and the electron beam irradiation amount are preferably set to values the same as the values described in the above-described method for producing a three-dimensional shaped object. By setting the oxygen concentration in electron beam irradiation area 120 to fall within the above range, the surface of a thin layer composed of three-dimensional modeling composition 102 is less likely to be cured, thereby increasing the adhesive strength with a shaped object layer to be formed later.

Lastly, the partition (not shown) between application area 110 and electron beam irradiation area 120 is opened again, and transport mechanism 113 moves shaping stage 101 to the application area 110 side. In this manner, the application of three-dimensional modeling composition 102 in application area 110 and the irradiation of the composition with an electron beam in electron beam irradiation area 120 are repeated to produce a three-dimensional shaped. object having a desired shape. When three-dimensional modeling composition 102 is finally cured in electron beam irradiation area 120, it is preferable that the oxygen concentration is set to lower than 50 ppm for sufficiently curing the surface of the composition.

In the above-described three-dimensional modeling apparatus 100, application area 110 includes only application part all for three-dimensional modeling composition 102. Application area 110 may further include, for example, an application apparatus (not shown) for applying a support material composition.

### EXAMPLES

Hereinafter, specific examples of the present invention will be described, The examples, however, shall not be construed as limiting the scope of the present invention.

Production of Resin Composition 1

Mixed were 50 mass % of trimethylolpropane triacrylate, 40 mass % of polyethylene glycol dimethacrylate, and 10 mass % of urethane acrylate (UA-1100 H, manufactured by Shin-Nakamura Chemical Co., Ltd.). The mixture was stirred at a rotation speed of 600 rpm for 10 minutes by a high-speed disperser (Homogenizing Mixer Model 2.5, manufactured by PRIMIX Corporation).

Production of Resin Composition 2

Mixed were 90 mass % of diallyl phthalate monomer (DAISO DAP monomer, manufactured by OSAKA SODA CO., LTD.) and 10 mass % of diallyl phthalate prepolymer (DAISO DAP A, manufactured by OSAKA SODA CO., LTD.). The mixture was stirred at a rotation speed of 600 rpm for 10 minutes by the high-speed disperser (Homogenizing Mixer Model 2.5, manufactured by PRIMIX Corporation).

Production of Resin Composition 3

Mixed were 10 mass % of urethane diacrylate (CN983, manufactured by Sartomer Company, Inc.), 80 mass % of trimethylpropane triacrylate, and 10% by mass of talc (Nanotalc D-600 (average particle size 0.6 μm), manufactured by NIPPON TALC Co., Ltd.). The mixture was kneaded for 10 minutes at an orbital revolution of 60 rpm and an own axis rotation of 180 rpm using a planetary kneader (HIVIS MIX 2P-1, manufactured by PRIMIX Corporation).

### Example 1

A dispenser syringe (not shown) disposed in application area 110 of three-dimensional modeling apparatus 100 illustrated in FIG. 2 was filled with resin composition 1 as the three-dimensional modeling composition, While shaping stage 101 was scanned in the horizontal direction, three-dimensional modeling composition 102 was discharged from dispenser needle 112 (DPN-18G-1, manufactured by Musashi Engineering, Inc.) connected to the dispenser syringe (not shown) to form a thin layer composed of three-dimensional modeling composition 102. The thickness of the thin layer was set to be 0.1 mm. Subsequently, the thin layer was moved to electron beam irradiation area 120 of the three-dimensional modeling apparatus. Electron beam irradiation area 120 had a. nitrogen atmosphere and an oxygen concentration of 60 ppm. The oxygen concentration was specified by an oxygen analyzer LC-750L (manufactured by Toray Engineering Co., Ltd.) which was placed in the vicinity of a three-dimensional shaped object. Three-dimensional modeling composition 102 was then irradiated with an electron beam (electron beam irradiation amount: 40 kGy, acceleration voltage: 200 kV) and cured.

The cured resin composition for three-dimensional modeling (shaped object layer 103) was then moved to application area 110, and three-dimensional modeling composition. 102 was discharged again onto shaped object layer 103 to form a thin layer composed of three-dimensional modeling composition 102. Subsequently, the obtained laminate was moved to electron beam irradiation area 120 and irradiated with an electron beam under the same conditions as described above. By repeating these steps, a three-dimensional shaped object was produced so as to have a shape of a JIS K7161-2 (ISO 527-2) 1A type test piece. During the production, a three-dimensional shaped object as a tensile test piece for measuring the strength in the stacking direction was obtained so that the longitudinal direction of the test piece was set to be perpendicular to the stage, and a three-dimensional shaped object as a tensile test piece for measuring the strength in the non-stacking direction was obtained so that the thickness direction of the test piece was set to be perpendicular to the stage.

### Examples 2 and 3, and Comparative Examples 1 and 2

A three-dimensional shaped object was produced in the same manner as in Example 1 except that the oxygen concentration in the electron beam irradiation area of the three-dimensional modeling apparatus was changed as shown in Table 1.

### Example 4

A three-dimensional shaped object was produced in the same manner as in Example 2 except that the electron beam irradiation amount during the three-dimensional modeling was changed to 20 kGy.

### Example 5

A three-dimensional shaped object was produced in the same manner as in Example 2 except that the acceleration voltage during the three-dimensional modeling was changed to 100 kV and the thickness of each thin layer was set to 0.05 mm.

### Example 6

A three-dimensional shaped object was produced in the same manner as in Example 1 except that resin composition 2 was used as the three-dimensional modeling composition, the oxygen concentration was set to 50 ppm, and the electron beam irradiation amount was set to 60 kGy.

### Examples 7 and 8, and Comparative Examples 3 and 4

Three-dimensional shaped objects were produced in the same manner as in Example 6 except that the oxygen concentration in the electron beam irradiation area of the three-dimensional modeling apparatus was changed as shown in Table 1.

### Example 9

A three-dimensional shaped object was produced in the same manner as in Example I except that resin composition 3 was used as the three-dimensional modeling composition, the oxygen concentration was set to 50 ppm, and the electron beam irradiation amount was set to 50 kGy.

### Examples 10 and 11, and Comparative Examples 5 and 6

Three-dimensional shaped objects were produced in the same manner as in Example 9 except that the oxygen concentration in the electron beam irradiation area of the three-dimensional modeling apparatus was changed as shown in Table 1.

Evaluation

The outcome of modeling (whether the modeling was possible or not) and the strength of the three-dimensional shaped objects were measured by the following methods.
Outcome of Modeling

The outcome of modeling of the above-mentioned Examples and Comparative Examples was evaluated according to the following criteria. Good or better is practically allowable.

Excellent: The shaped object was completely cured at the end of modeling.

Good: The shaped object had some uncured parts at the end of modeling, but retained its shape.

Poor: The shaped object was not sufficiently cured at the end of modeling and could not retain its shape.
Measurement of tensile strengths in the stacking direction and in the non-stacking direction and calculation of ratio of the strengths

The strength of three-dimensional shaped objects produced in Examples and Comparative Examples were evaluated by a tensile test in accordance with JIS K7161-1. The distance between the grippers in the tensile test was set to 115 mm, and the test speed was set to 5 mm/min. The value obtained by dividing the stress at break by the cross-sectional area of the test piece was calculated as the tensile strength. Based on the strength measurement results of each test piece, the ratio between the strength in the stacking direction and the strength in the non-stacking direction was determined. Good or better is practically allowable.

Excellent: The stacking direction strength/non-stacking direction strength was 0.80 or more,

Good: The stacking direction strength/non-stacking direction strength was 0.50 or more and less than 0.8,

Poor: The stacking direction strength/non-stacking direction strength was less than 0.50.

TABLE 1

| | | | | | | | Strength ratio between |
|---|---|---|---|---|---|---|---|
| | | | | | | | stacking direction and |
| | | Oxygen concentration | Electron beam | Acceleration | Film thickness | | non-stacking direction of |
| | | during electron beam | irradiation | voltage | of thin layer | Outcome of | three-dimensional shaped |
| | Composition | irradiation (ppm) | amount (kGy) | (kV) | (mm) | modeling | object |
| Comparative | 1 | 40 | 40 | 200 | 0.1 | Excellent | Poor |
| Example 1 | | | | | | | |
| Example 1 | 1 | 60 | 40 | 200 | 0.1 | Excellent | Good |
| Example 2 | 1 | 300 | 40 | 200 | 0.1 | Excellent | Excellent |
| Example 3 | 1 | 4,500 | 40 | 200 | 0.1 | Good | Excellent |
| Comparative | 1 | 5,500 | 40 | 200 | 0.1 | Poor | — |
| Example 2 | | | | | | | |
| Example 4 | 1 | 300 | 20 | 200 | 0.1 | Excellent | Excellent |
| Example 5 | 1 | 300 | 40 | 100 | 0.05 | Excellent | Excellent |
| Comparative | 2 | 30 | 60 | 200 | 0.1 | Excellent | Poor |
| Example 3 | | | | | | | |
| Example 6 | 2 | 50 | 60 | 200 | 0.1 | Excellent | Good |
| Example 7 | 2 | 400 | 60 | 200 | 0.1 | Excellent | Excellent |
| Example 8 | 2 | 4,800 | 60 | 200 | 0.1 | Good | Excellent |
| Comparative | 2 | 5,800 | 60 | 200 | 0.1 | Poor | — |
| Example 4 | | | | | | | |
| Comparative | 3 | 40 | 50 | 200 | 0.1 | Excellent | Poor |
| Example 5 | | | | | | | |
| Example 9 | 3 | 50 | 50 | 200 | 0.1 | Excellent | Good |
| Example 10 | 3 | 200 | 50 | 200 | 0.1 | Excellent | Excellent |
| Example 11 | 3 | 3,500 | 50 | 200 | 0.1 | Good | Excellent |
| Comparative | 3 | 5,200 | 50 | 200 | 0.1 | Poor | — |
| Example 6 | | | | | | | |

As shown in Table 1, when the oxygen concentration in the atmosphere during electron beam irradiation was 50 ppm or more and less than 5000 ppm, the three-dimensional modeling composition could be cured (shaped) (Examples 1 to 3). With the oxygen concentration in the above range, the strength of the obtained three-dimensional shaped object (strength ratio between the stacking direction and the non-stacking direction of the three-dimensional shaped object) was also sufficient.

When the oxygen concentration during electron beam irradiation was less than 50 ppm, it was possible to model a three-dimensional shaped object, but the strength of the object was insufficient (Comparative Examples 1, 3, and 5). The reason for this may be because the entire three-dimensional modeling composition was excessively cured by the irradiation with the electron beam, and the adhesive strength between the previously formed shaped object layer and the later formed shaped object layer became insufficient.

When the oxygen concentration was 5,000 ppm or more, it was difficult to model a three-dimensional shaped object in the first place (Comparative Examples 2, 4, and 6). The reason for this may be because modeling was not possible due to excessive oxygen inhibition occurred during electron beam irradiation.

This application claims the benefit of Japanese Patent Application No. 2019-018741 filed on Feb. 5, 2019, the disclosure of winch including the specification and drawings is incorporated herein by reference in its entirety.

### INDUSTRIAL APPLICABILITY

The method for producing a three-dimensional shaped object according to the present invention. can produce a three-dimensional shaped object having high strength by using electron beam irradiation. Therefore, the present invention is expected to contribute to further popularization of the three-dimensional modeling method,

### REFERENCE SIGNS LIST

1a, 1b, 1c Shaped object layer
2a Support material layer
10 Three-dimensional shaped object
100 Three-dimensional modeling apparatus
101 Shaping stage
102 Three-dimensional modeling composition
103 Shaped object layer
110 Application area
111 Application part
112 Dispenser needle
113 Transport mechanism
120 Electron beam irradiation area
121 Electron beam irradiation part

1. A method for producing a three-dimensional shaped object, the method comprising:
thin layer forming of applying in a pattern a three-dimensional modeling composition containing a radical polymerizable compound to form a thin layer; and
electron beam radiating of irradiating the thin layer with an electron beam to form a shaped object layer with tile radical polymerizable compound being cured therein,
wherein the thin layer forming and the electron beam radiating are repeated a plurality of times to stack a plurality of the shaped object layers on top of one another to produce a three-dimensional shaped object, and
wherein the electron beam radiating is performed in an atmosphere having an oxygen concentration of 50 ppm or more and less than 5,000 ppm.

2. The method for producing a three-dimensional shaped object according to claim 1, wherein:
the three-dimensional modeling composition is applied by a discharge method in the thin layer forming.

3. The method for producing a three-dimensional shaped object according to claim 1, wherein:
the three-dimensional modeling composition contains a filler.

4. A three-dimensional modeling apparatus, comprising:
a shaping stage;
an application area including an application part for applying a three-dimensional modeling composition on or above the shaping stage; and
an electron beam irradiation area including an electron beam irradiation part for irradiating the three-dimensional modeling composition applied in the application area with an electron beam,
wherein
the three-dimensional modeling apparatus is provided with an oxygen concentration adjustment pail for adjusting an oxygen concentration in the electron beam irradiation area.

5. The three-dimensional modeling apparatus according to claim 4, further comprising:
a transport mechanism capable of transporting the shaping stage, wherein
the shaping stage is moved between the application area and the electron beam irradiation area.
